(19) United States
(12) Patent Application Publication
(10) Pub. No.: US 2012/0064437 A1
(43) Pub. Date: Mar. 15, 2012

(54) PLATINUM-CONTAINING CATALYST AND FUEL CELL USING THE SAME

(75) Inventors: Yoshihiro Kudo, Tokyo (JP); Shuji Goto, Tokyo (JP)

(73) Assignee: SONY CORPORATION, Tokyo (JP)

(21) Appl. No.: 13/320,939

(22) PCT Filed: May 25, 2010
(86) PCT No.: PCT/JP2010/058788

§ 371 Date: Nov. 17, 2011

(30) Foreign Application Priority Data
Jun. 1, 2009 (JP) 2009-131689

(51) Int. Cl. H01M 4/92; B01J 23/46; B01J 23/42; B82Y 30/00

(52) U.S. Cl. 429/524; 502/339; 977/773

(57) ABSTRACT

A platinum-containing catalyst that is able to optimize state density of platinum 5d vacant orbital and is able to improve catalyst activity and a fuel cell using the same are provided. In the platinum-containing catalyst, when ratio of a peak intensity of a PtLIII absorption edge of a normalized X-ray absorption spectrum of the platinum-containing catalyst with respect to a peak intensity of a PtLIII absorption edge of a normalized X-ray absorption spectrum of a platinum simple substance metal foil having a thickness of 10 μm is Y, the number of holes of a platinum 5d vacant orbital in the platinum simple substance metal foil is 0.3, the number of holes of a platinum 5d vacant orbital in the platinum-containing catalyst is N, and molar ratio of total of metal elements other than platinum to the platinum in the platinum-containing catalyst is X, Y=0.144X+1.060 is established in the range of 0.1≦X≦1, and N=0.030X+0.333 is established in the range of 0.1≦X≦1.

### TECHNICAL FIELD

The present invention relates to a platinum-containing catalyst and a fuel cell using the same.

### BACKGROUND ART

Since fuel cells that convert chemical energy into electric energy are effective and do not emit environmental pollutants, the fuel cells have attracted attentions as a clean power source for portable information devices, household appliances, vehicles and the like, and have been progressively developed.

The fuel cells include various types according to the electrolyte type to be used. In particular, a fuel cell using an organic material such as methanol and hydrogen as a fuel have attracted attentions. Important component materials that determine output performance of the fuel cell are an electrolyte material and a catalyst material. A membrane electrode assembly (MEA) in which both sides of an electrolyte film are sandwiched between catalyst films is an important component. As the electrolyte material, many types of materials have been examined. For example, one of representative examples is an electrolyte composed of a perfluorosulfonic acid resin. Further, as a catalyst material, many types of materials have been examined. For example, one of representative examples is PtRu catalyst. In addition to the PtRu catalyst, for obtaining a catalyst having high activity, binary catalysts PtM in which M is Au, Mo, W or the like have been examined.

In a fuel electrode of a direct methanol fuel cell (DMFC), for example, in the case where a binary metal catalyst using Pt and Ru is used, in deprotonation reaction shown in Formula (1), methanol is oxidized, CO is generated and is absorbed into Pt, and Pt—Co is generated. In reaction shown in Formula (2), water is oxidized, OH is generated and is absorbed into Ru, and Ru—OH is generated. Finally, in reaction shown in Formula (3), absorbed CO is oxidized by Ru—OH and is removed as CO₂, and electric charge is generated. Ru acts as a promoter.

Pt+CH₃OH→Pt—Co+4H⁺+4e⁻ (1)

Ru+H₂O→Ru—OH+H⁺+e⁻ (2)

Pt—Co+Ru—OH→Pt+Ru+CO₂+H⁺+e⁻ (3)

The principle that methanol is oxidized by a series of reactions shown in Formulas (1), (2), and (3) is widely known as bifunctional mechanism in which CO absorbed into Pt and a hydroxyl group bonded to Ru adjacent to Pt are reacted with each other to convert CO into CO₂, and thereby catalyst poisoning by CO is inhibited.

Aside from the foregoing description, it is known that under the conditions where Pt is electronically affected by adjacent Ru, Pt—Co is possibly oxidized by water by reaction shown in Formula (4) following Formula (1) (for example, see the after-mentioned Non-patent document 1).

Pt—CO+H₂O→Pt+CO₂+2H⁺+2e⁻ (4)

Catalyst composition has been actively examined. Extremely many reports have been made on examination of optimization of molar ratio between Pt and Ru in a catalyst that is applied to the fuel cells and that contains Pt and Ru (for example, see Patent document 1, Patent document 2, and Patent document 3 described below).

For structural-chemical examination of catalysts, X-ray absorption fine structure (XAFS) obtained by X-ray absorption spectrum has been used (for example, see Non-patent document 2 described below). Structural-chemical examination of the catalysts applied to the fuel cells has been also made. For example, there is a report of analyzing a profile corresponding to a radial distribution function centering on an X-ray absorption atom based on Fourier transformation of the X-ray absorption fine structure (XAFS) (for example, see Patent document 4 and Patent document 5 described below).

Further, examinations on electron state in a platinum catalyst have been made, and many reports thereon have been made. For example, theoretical analysis and experiments for obtaining the number of holes of palladium 5d orbital and the like have been made (for example, see Non-patent document 3 to Non-patent document 8 described below).

### CITATION LIST

### Patent Document

Patent document 1: Japanese Unexamined Patent Application Publication No. 2006-190686 (paragraph 0014), “Pt/Ru ALLOY CATALYST, METHOD OF MANUFACTURING THE SAME, FUEL CELL-USE ELECTRODE, AND FUEL CELL”
Patent document 2: WO No. 2007-029607 (paragraph 0049, FIG. 3), “NOBLE METAL MICROPARTICLE AND METHOD FOR PRODUCTION THEREOF”
Patent document 3: Japanese Unexamined Patent Application Publication No. 2007-285598 (paragraph 074, FIG. 5), “DIRECT METHANOL FUEL CELL-USE MEMBRANE ELECTRODE ASSEMBLY AND METHOD OF MANUFACTURING THE SAME”
Patent document 4: Japanese Unexamined Patent Application Publication No. 2008-171659 (paragraph 0040)
Patent document 5: Japanese Unexamined Patent Application Publication No. 2008-1753146 (paragraph 0036)

### Non-Patent Document

Non-patent document 1: A. Hamnett, “Mechanism and electrocatalysis in the direct methanol fuel cell,” Catalysis Today 38 (1997) 445-457 (5. Mechanism for promotion of platinum by ruthenium)
Non-patent document 2: document 2: “X-ray Absorption Fine Structure (Xafs for Catalysts and Surfaes,” Yasuhiro Iwasawa, World Scientific Pub Colnc (1998 August)
Non-patent document 3: document 3: A. N. Mansour et al., “Quantitative Technique for the Determination of the Number of Unoccupied d-Electron States Ia Platinum Catalyst Using the L2,3 X-ray Absorption Edge Spectra,” J. Phys. Chem. 1984, 2330-2334 (III. Quantitative Technique for the Determination of d-Electron Character)
Non-patent document 4: M. Brown et al., “White lines in X-ray absorption,” Phys. Rev. B 15, 738-744 (1977) (III. ABSORPTION CONTRIBUTION OF THE WHITE LINE),
Non-patent document 5: L. F. Mattheiss and R. E. Dietz, “Relativistic tight-binding calculation of core-valence transitions in Pt and Au,” Phys. Rev. B22, 1663-1676 (1980) (TABLE II)
Non-patent document 6: N. V. Smith et al., “Photoemission spectra and band structures of d-band metals. IV. X-ray photoemission spectra and densities of states in Rh, Pd, Ag, Ir, Pt, and Au,” Phys. Rev. B 10, 3197-3206 (1974)
Non-patent document 7: S. Mukerjee et al., “Effect of Preparation Conditions of Pt Alloys on Their Electronic, Structural, and Electrocatalytic Activities for Oxygen Reduction-XRD, XAS, and Electrochemical Studies,” J. Phys. Chem. 99 (1995)4577-4587 (In-Situ XAS Data Analysis., EXAFS and XANES Analysis at the Pt Ede., TABLE 5)
Non-patent document 8: S. Mukerjee, R. C Urian, “Bifunctionality in Pt alloy nanocluster electrocatalysts for enhanced methanol oxidation and CO tolerance in PEM fuel cells: electrochemical and in situ synchrotron spectroscopy,” Electrochemica Acta 47 (2002) 3219-3231 (Table 3),

### SUMMARY OF THE INVENTION

Change of reaction on Pt due to influence of Ru as shown in the foregoing Formula (4) may be caused by the following fact. That is, electrons are supplied from Pt to Ru, that is, state density of platinum 5d vacant orbital higher than Pt Fermi level is increased. Thereby, electron back donation from Pt to π* orbital of C of a CO group is less likely to be generated, Pt—Co bond is weakened, and oxidation by H₂O is enabled.

In such methanol oxidation, reaction rate is possibly higher than that of a case of a fuel electrode based on bifunctional mechanism that needs oxidation of CO strongly bonded to Pt, resulting in an advantage for attaining high performance of the direct methanol fuel cell.

As described above, it is necessary to change electron state of Pt. Meanwhile, dehydrogenation reaction of methanol of Formula (1) is a reaction easily generated on the Pt surface. Large change from primary electron state of Pt possibly has an adverse effect on methanol oxidation reaction rate. Thus, it is desirable that the state density of the platinum 5d vacant orbital be optimized and catalyst activity is more improved. In the past, catalysts capable of further improving catalyst activity have not been examined considering the state density of the platinum 5d vacant orbital.

The present invention is made for solving the foregoing problems, and it is an object of the present invention to provide a platinum-containing catalyst with which the state density of the platinum 5d vacant orbital is optimized and catalyst activity is able to be improved and a fuel cell using the same.

In a first platinum-containing catalyst according to the present invention, when ratio of a peak intensity of a PtLIII absorption edge of a normalized X-ray absorption spectrum of the platinum-containing catalyst with respect to a peak intensity of a PtLIII absorption edge of a normalized X-ray absorption spectrum of a platinum simple substance metal foil having a thickness of 10 μm is Y, and molar ratio of total of metal elements other than platinum to the platinum in the platinum-containing catalyst is X, Y=0.144X+1.060 is established in the range of 0.1≦X≦1.

In a second platinum-containing catalyst according to the present invention, when the number of holes of a platinum 5d vacant orbital in a platinum simple substance metal foil is 0.3, molar ratio of total of metal elements other than platinum to the platinum in the platinum-containing catalyst is X, and the number of holes of a platinum 5d vacant orbital in the platinum-containing catalyst is N, N=0.030X+0.333 is established in the range of 0.1≦X≦1.

In a third platinum-containing catalyst according to the present invention, when ratio of a peak intensity of a PtLIII absorption edge of a normalized X-ray absorption spectrum of the platinum-containing catalyst with respect to a peak intensity of a PtLIII absorption edge of a normalized X-ray absorption spectrum of a platinum simple substance metal foil having a thickness of 10 μm is Y, and molar ratio of total of metal elements other than platinum to the platinum in the platinum-containing catalyst is X, Y=0.144X+1.060 is established in the range of 0.1≦X≦1, and when the number of holes of a platinum 5d vacant orbital in the platinum simple substance metal foil is 0.3 and the number of holes of a platinum 5d vacant orbital in the platinum-containing catalyst is N, N=0.030X+0.333 is established in the range of 0.1≦X≦1.

A fuel cell according to the present invention has a catalyst electrode using the foregoing platinum-containing catalyst.

According to the first platinum-containing catalyst of the present invention, when the ratio of the peak intensity of the PtLIII absorption edge of the normalized X-ray absorption spectrum of the platinum-containing catalyst with respect to the peak intensity of the PtLIII absorption edge of the normalized X-ray absorption spectrum of the platinum simple substance metal foil having a thickness of 10 μm is Y, and the molar ratio of the total of the metal elements other than the platinum to the platinum in the platinum-containing catalyst is X, Y=0.144X+1.060 is established in the range of 0.1≦X≦1. Thus, the state density of the platinum 5d vacant orbital is optimized for the purpose of improving catalyst activity. Accordingly, catalyst activity is able to be improved.

Further, according to the second platinum-containing catalyst of the present invention, when the number of holes of the platinum 5d vacant orbital in the platinum-containing simple substance metal foil is 0.3, the molar ratio of the total of the metal elements other than the platinum to the platinum in the platinum-containing catalyst is X, and the number of holes of the platinum 5d vacant orbital in the platinum-containing catalyst is N, N=0.030X+0.333 is established in the range of 0.1≦X≦1. Accordingly, the state density of the platinum 5d vacant orbital is optimized, and catalyst activity is able to be improved.

Further, according to the third platinum-containing catalyst of the present invention, when the ratio of the peak intensity of the PtLIII absorption edge of the normalized X-ray absorption spectrum of the platinum-containing catalyst with respect to the peak intensity of the PtLIII absorption edge of the normalized X-ray absorption spectrum of the platinum simple substance metal foil having a thickness of 10 μm is Y, and the molar ratio of the total of the metal elements other than the platinum to the platinum in the platinum-containing catalyst is X, Y=0.144X+1.060 is established in the range of 0.1≦X≦1, and when the number of holes of the platinum 5d vacant orbital in the platinum simple substance metal foil is 0.3 and the number of holes of the platinum 5d vacant orbital in the platinum-containing catalyst is N, N=0.030X+0.333 is established in the range of 0.1≦X≦1. Accordingly, the state density of the platinum 5d vacant orbital is optimized, and catalyst activity is able to be improved.

Furthermore, according to the fuel cell of the present invention, the platinum-containing catalyst having improved catalyst activity is used, and thus, power generation characteristics are improved.

### BRIEF DESCRIPTION OF DRAWINGS

FIG. 1 is a cross sectional view for explaining a structural example of a DMFC in an embodiment of the present invention.

FIG. 2 is a diagram for explaining normalization of X-ray absorption spectrums of PtL absorption edges and X-ray absorption intensities.

FIG. 3 is a diagram for explaining compositions of PtRu catalyst and characteristics thereof in the examples of the present invention.

FIG. 4 is a diagram for explaining an example of normalized X-ray absorption spectrums (PtLIII).

FIG. 5 is a diagram for explaining an example of normalized X-ray absorption spectrums (PtLII).

FIG. 6 is a diagram for explaining an example of the normalized X-ray absorption spectrums (enlarged diagram, PtLIII).

FIG. 7 is a diagram for explaining an example of the normalized X-ray absorption spectrums (enlarged diagram, PtLII).

FIG. 8 is a diagram illustrating a relation between the compositions of the PtRu catalyst and peak intensities of the PtLIII absorption edge.

FIG. 9 is a diagram for explaining X-ray absorption spectrums of a Pt foil with its energy axis adjusted.

FIG. 10 is a diagram for explaining a relation between the compositions of the PtRu catalyst and the number of holes of platinum 5d vacant orbital.

FIG. 11 is a cross sectional view for explaining a structure of a fuel cell

FIG. 12 is a diagram for explaining power generation characteristics of the fuel cell.

### DESCRIPTION OF EMBODIMENT

In a platinum-containing catalyst of the present invention, when molar ratio of platinum to the total of metal elements is X′, Y=−0.043X′+1.228 is preferably established in the range of 1≦X′≦2.5, and Y=−0.007X′+1.131 is preferably established in the range of 2.5≦X′≦10. According to such a structure, state density of platinum 5d vacant orbital is optimized for the purpose of improving catalyst activity. Accordingly, a platinum-containing catalyst capable of improving catalyst activity is able to be provided.

In the platinum-containing catalyst of the present invention, when molar ratio of platinum to the total of the metal elements is X′, N=−0.011X′+0.372 is preferably established in the range of 1≦X′≦2.5 and N=−0.001X′+0.345 is preferably established in the range of 2.5≦X′≦10. According to such a structure, the state density of the platinum 5d vacant orbital is optimized, and a platinum-containing catalyst capable of improving catalyst activity is able to be provided.

In the platinum-containing catalyst of the present invention, when molar ratio of platinum to the total of metal elements is X′, Y=−0.043X′+1.228 is preferably established in the range of 1≦X′≦2.5, Y=−0.007X′+1.131 is preferably established in the range of 2.5≦X′≦10, N=−0.011X′+0.372 is preferably established in the range of 1≦X′≦2.5, and N=−0.001X′+0.345 is preferably established in the range of 2.5≦X′≦10. According to such a structure, the state density of the platinum 5d vacant orbital is optimized, and a platinum-containing catalyst capable of improving catalyst activity is able to be provided.

In the platinum-containing catalyst of the present invention, the molar ratio is preferably 0.25≦X≦1, is more preferably 0.2≦X≦0.6, and is much more preferably 0.4≦X≦0.6. According to such a structure, ruthenium acts as a promoter, and the state density of the platinum 5d vacant orbital is optimized. Accordingly, a platinum-containing catalyst capable of improving catalyst activity is able to be provided, and a fuel cell with superior power generation characteristics is able to be realized.

In the platinum-containing catalyst of the present invention, the metal element is preferably ruthenium. According to such a structure, ruthenium acts as a promoter, and the state density of the platinum 5d vacant orbital is optimized. Accordingly, a platinum-containing catalyst capable of improving catalyst activity is able to be provided, and a fuel cell with superior power generation characteristics is able to be realized.

In a fuel cell of the present invention, a catalyst electrode is preferably used for a fuel electrode side. According to such a structure, a platinum-containing catalyst with the larger number of holes of the platinum 5d vacant orbital is used for the catalyst electrode on the fuel electrode side. Therefore, a fuel cell with superior power generation characteristics is able to be provided.

An embodiment of the present invention will be hereinafter described in detail with reference to the drawings.

### EMBODIMENT

### Pt-Containing Catalyst

A PtRu catalyst supported by carbon is formed as follows. Ruthenium chloride aqueous solution and sodium acetate are mixed to obtain uniform solution. After that, carbon black is added to the solution, the resultant is stirred to uniformly disperse the carbon black. While stirring is continued, boron sodium hydroxide aqueous solution is dropped to the solution to obtain carbon-supported Ru nanoparticle dispersion liquid. While the dispersion liquid is stirred, chloroplatinic aqueous solution and boron sodium hydroxide aqueous solution are concurrently dropped and added, and thereby carbon-supported PtRu nanoparticle dispersion liquid is obtained. The concentration and the additive volume of the chloroplatinic aqueous solution and the boron sodium hydroxide aqueous solution are specified so that the molar ratio of Ru to Pt is obtained as a given value. The PtRu nanoparticles supported by carbon are collected by using a centrifugal machine, and is purified with the use of a large quantity of water.

<Fuel Cells to which the Pt-Containing Catalyst is Applied>

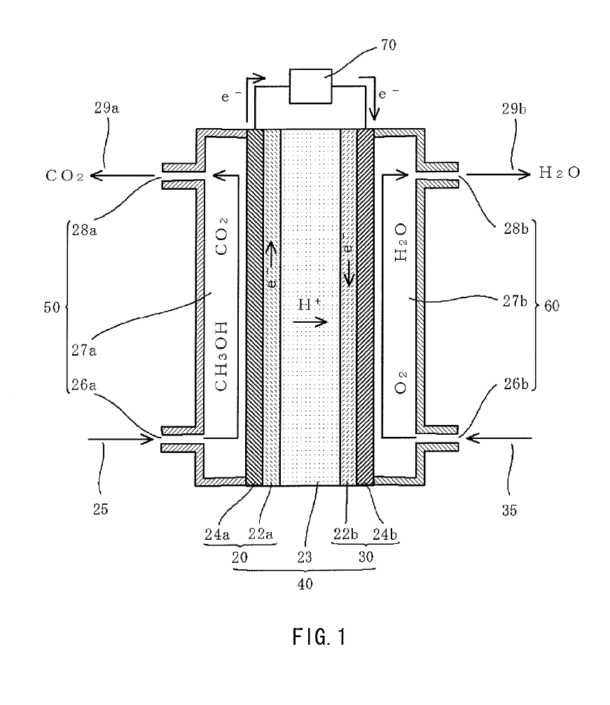

FIG. 1 is a cross sectional view for explaining a structural example of a DMFC (direct methanol fuel cell) in an embodiment of the present invention.

In the DMFC, methanol aqueous solution as a fuel 25 is flown from an inlet 26a of a fuel supply section (separator) 50 having a flow path to a path 27a, passes through a conductive gas diffusion layer 24a as a substrate, and reaches a catalyst electrode 22a supported by the conductive gas diffusion layer 24a. Thereby, according to anode reaction illustrated in the lower section of FIG. 1, methanol is reacted with water on the catalyst electrode 22a, hydrogen ions, electrons, carbon dioxide are generated, and exhaust gas 29a containing carbon dioxide is exhausted from an outlet 28a. The generated hydrogen ions pass through a polymer electrolyte film 23 formed from proton conductive composite electrolyte. The generated electrons pass through the gas diffusion layer 24a and an external circuit 70, further pass through a conductive gas diffusion layer 24b as a substrate, and reaches a catalyst electrode 22b supported by the gas diffusion layer 24b.

Air or oxygen 35 is flown from an inlet 26b of an air/oxygen supply section (separator) 60 having a flow path to a path 27b, passes through the gas diffusion layer 24b, and reaches the catalyst electrode 22a supported by the gas diffusion layer 24b. Thereby, according to cathode reaction illustrated in the lower section of FIG. 1, on the catalyst electrode 22b, hydrogen ions, electrons, and oxygen are reacted with each other, water is generated, and exhaust gas 29b containing water is exhausted from an outlet 28b. As illustrated in the lower section of FIG. 1, entire reaction is methanol combustion reaction where electric energy is extracted from methanol and oxygen, and water and carbon dioxide are exhausted.

The polymer electrolyte film 23 is formed by bonding the proton conductive composite electrolyte by a binder (for example, polytetrafluoroethylene (PTFE), polyvinylidene fluoride (PVDF) or the like). An anode 20 is separated from a cathode 30 by the polymer electrolyte film 23. Hydrogen ions and water molecules are moved through the polymer electrolyte film 23. The polymer electrolyte film 23 is a film that highly conducts hydrogen ions. The polymer electrolyte film 23 is preferably stable chemically and preferably has high mechanical strength.

The catalyst electrodes 22a and 22b structure a conductive substrate as a current collector, and are formed firmly on the gas diffusion layers 24a and 24b permeable to gas and solutions. The gas diffusion layers 24a and 24b are composed of a porous substrate made of carbon paper, carbon compact, sintered carbon, a sintered metal, a foamed metal or the like. To prevent lowering of gas diffusion efficiency due to water generated by driving a fuel cell, the gas diffusion layer is provided with water repellent treatment with a fluorine resin or the like.

The catalyst electrodes 22a and 22b are formed by binding a support that supports a catalyst composed of, for example, platinum, ruthenium, osmium, a platinum-osmium alloy, a platinum-palladium alloy or the like by a binder (for example, polytetrafluoroethylene, polyvinylidene fluoride (PVDF) or the like). As the support, for example, carbon such as acetylene black and graphite or inorganic fine particles such as alumina and silica is used. The gas diffusion layers 24a and 24b are coated with a solution obtained by dispersing carbon particles (supporting a catalyst metal) in an organic solvent dissolving a binder, the organic solvent is vaporized, and thereby the film-like catalyst electrodes 22a and 22b that are bound by the binder are formed.

The polymer electrolyte film 23 is sandwiched between the catalyst electrodes 22a and 22b formed firmly on the gas diffusion layers 24a and 24b, and thereby a membrane electrode assembly (MEA) 40 is formed. The anode 20 is composed of the catalyst electrode 22a and the gas diffusion layer 24a. The cathode 30 is composed of the catalyst electrode 22b and the gas diffusion layer 24b. The anode 20 and the cathode 30 are contacted with the polymer electrolyte film 23, proton conductor gets into a gap between carbon particles, and thereby the catalyst electrodes 22a and 22b are impregnated with the polymer electrolyte (proton conductor) and the catalyst electrodes 22a and 22b are jointed firmly to the polymer electrolyte film 23, hydrogen ion high conductivity is retained at the joint interface, and electric resistance is retained low.

In the example shown in FIG. 1, respective opening sections that are the inlet 26a of the fuel 25, the outlet 28a of the exhaust gas 29a, an inlet 26b of air or oxygen (O₂) 35, and an outlet 28b of exhaust gas 29b are arranged perpendicular to faces of the polymer electrolyte film 23 and the catalyst electrodes 22a and 22b. However, the foregoing respective aperture sections may be arranged in parallel with the faces of the polymer electrolyte film 23 and the catalyst electrodes 22a and 22b. For arrangement of the foregoing respective aperture sections, various modifications are enabled.

In the foregoing manufacture of the fuel cell, a general method disclosed in various documents is able to be used. Thus, detailed description of the manufacture will be omitted.

<Characteristics and X-Ray Absorption Spectrum of the Pt-Containing Catalyst>

X-ray absorption fine structure (XAFS) measurement is a measurement method with which material local structure information, for example, chemical bond state such as the coordination number and valence of absorption elements and absorption atoms, distribution of distance between an absorption atom and an atom around/in the vicinity of the absorption atom and the like is able to be obtained by measuring wavelength dependence of X-ray absorption intensity (absorbance) of a material.

Regarding X-ray absorption near-edge structure (XANES) shown in about several tens of eV from an absorption edge, an absorption spectrum is formed by effect of electron transition from an inner shell to unoccupied level. The spectrum shape is extremely sensitively reflected by chemical bond state information such as the coordination number and valence of an absorption atom.

Regarding extended X-ray absorption fine structure (EXAFS) shown in about 1000 eV from an absorption edge, photoelectrons emitted from an absorption atom are scattered by surrounding atoms, transition probability of the photoelectrons is modulated by interference between emitted electron wave and scattered electron wave, and a wave-like structure is shown in the spectrum. By analyzing the wave-like structure, distribution information of atomic distance between the absorption atom and atoms around the absorption atom is able to be obtained.

In the case where an electron in inner shell 2p orbital of a Pt atom is excited, the electron is transferred to platinum 5d vacant orbital due to electric dipole transition. The state density of the platinum 5d vacant orbital is reflected by absorption intensity of an X-ray absorption spectrum in LIII absorption edge or LII absorption edge in the case where X-ray having energy equal to or larger than transition energy is irradiated.

In this embodiment, based on analysis of the X-ray absorption near-edge structure (XANES), a peak intensity of the PtLIII absorption edge is obtained, and thereby the state density of the platinum 5d vacant orbital of the platinum-containing catalyst giving optimum catalyst activity is determined.

The peak intensity of the PtLIII absorption edge of the platinum catalyst is a relative intensity. A peak intensity of PtLIII absorption edge of a normalized X-ray absorption spectrum of a platinum simple substance metal foil being 10 μm thick is used as a standard. Ratio of a peak intensity of PtLIII absorption edge of a normalized X-ray absorption spectrum of the platinum-containing catalyst with respect to the foregoing standard is used. It is to be noted that the absorption peak intensity is an average value of one Pt atom.

Further, by taking account of both peak intensities of the PtLIII absorption edge and the LII absorption edge, the state density of the platinum 5d vacant orbital is able to be obtained as the number of holes that is a quantitative numerical value. By using the Pt simple substance metal foil as a standard, the foregoing number of holes is obtained with the use of the number of holes of platinum 5d vacant orbital in the platinum simple substance metal foil of 0.3. It is to be noted that the number of holes is an average value of one Pt atom.

Next, a description will be given of a summary of measuring X-ray absorption spectrums and normalization thereof.

<Normalization of X-Ray Absorption Spectrums for Evaluating Characteristics of the Pt-Containing Catalyst>

### (Measurement of X-Ray Absorption Spectrums)

Catalyst particles supported by carbon are used as a sample, and an X-ray absorption spectrum thereof is measured as follows. A tape is uniformly coated with the catalyst particles, and the number thereof is adjusted so that an adjacent absorption intensity is obtained. The X-ray absorption spectrum is measured for the Pt LIII absorption edge and the Pt LII absorption edge by using a synchrotron orbital radiation experiment facility (SPring-8).

The X-ray absorption spectrum is able to be measured by transmission method and/or fluorescence method. As a reference sample, a Pt metal foil is used and an absorption spectrum thereof is measured. The absorption spectrum of the PtLIII absorption edge is able to be obtained by the fluorescence method as follows. While adjusting incident X-ray energy back and forth the PtLIII edge, fluorescent X-ray intensity If generated by exciting the PtLIII edge by each energy is measured, and the resultant measurement value is divided by incident X-ray intensity I0 (If/I0), by which the absorption spectrum is able to be obtained. The absorption spectrum of the Pt LII absorption edge is able to be similarly obtained.

(Normalization of the X-Ray Absorption Spectrums)

To obtain the peak intensity of an absorption spectrum of X-ray absorption edge, the spectrum should be normalized for correcting difference according to Pt density or the like, entire spectrum shape and the like. Such normalization process should be appropriately and reasonably performed since such normalization process has an influence on the peak intensity.

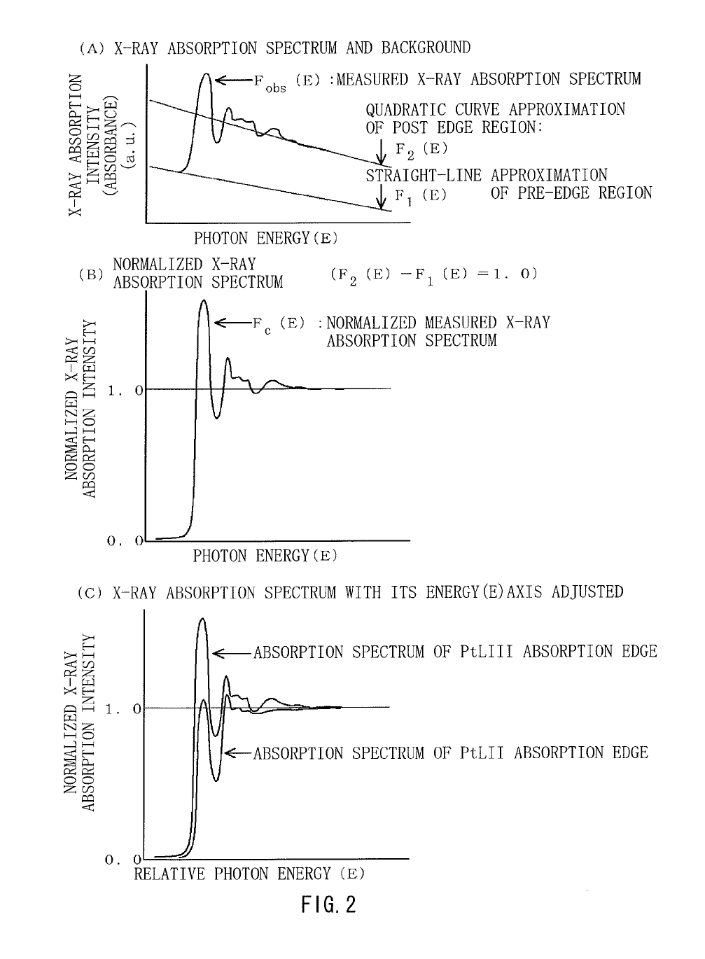

FIG. 2 is a diagram for explaining normalization of the X-ray absorption spectrums of the PtL absorption edges and the X-ray absorption intensity in this embodiment.

FIG. 2(A) is a diagram for explaining the X-ray absorption spectrum and background (background curve). The horizontal axis indicates photon energy (E), the vertical axis indicates the X-ray absorption intensity (absorbance) (given unit), and F_{obs} (E) indicates the measured X-ray absorption spectrum. In FIG. 2(A), F₂(E) indicates background obtained by quadratic curve-approximating a spectrum in the post edge region (region with higher energy than that of the absorption edge), and F₁(E) indicates background obtained by straight-line-approximating a spectrum in the pre-edge region (region with lower energy than that of the absorption edge).

FIG. 2(B) indicates a normalized X-ray absorption spectrum (Fc (E)), and the vertical axis indicates the intensity thereof. The normalized X-ray absorption spectrum (Fc (E)) is normalized by subtracting the background F₁(E) illustrated in FIG. 2(A) from the measured X-ray absorption spectrum F_{obs} (E), and setting difference between the backgrounds F₁(E) and F₂(E) illustrated in FIG. 2(A) to 1.0 as each value of photon energy E, and is able to be obtained by Fc (E)={(F_{obs} (E)−F₁(E))/(F₂(E)−F₁(E))}. Accordingly, the entire spectrum is normalized.

FIG. 2(C) illustrates X-ray absorption spectrums obtained by adjusting the horizontal axis (photon energy E) of the normalized X-ray absorption spectrums of the PtLIII absorption edge and the PtLII absorption edge, that is, spectrums obtained by adjusting the energy axis (E) so that extended X-ray absorption fine structure (EXAFS) becomes conformable.

X-ray absorption near-edge structure (XANES) appearing in the vicinity of the absorption edge illustrated in FIG. 2(C) is an absorption spectrum due to electron transition from an inner shell to unoccupied level. The shape thereof reflects chemical bond state such as the coordination number and valence of atoms related to energy absorption. In FIG. 2(C), the horizontal axis indicates relative photon energy (E) obtained by commonalizing the energy axis (horizontal axis) of the LIII edge absorption spectrum and the LII edge absorption spectrum, the vertical axis indicates intensities of the normalized X-ray absorption spectrums (X-ray absorption intensity) of the PtLIII absorption edge and the PtLII absorption edge, and the integration range is commonalized.

The state density of the platinum 5d vacant orbital is able to be obtained as the number of holes as a quantitative numerical value by using the normalized X-ray absorption spectrums of the PtLIII absorption edge and the PtLII absorption edge illustrated in FIG. 2(C) according to the method reported in Non-patent documents 3 to 5 as follows.

<The Number of Holes of the Platinum 5d Vacant Orbital in the Pt-Containing Catalyst>

The number of holes h_{TS} of the platinum 5d vacant orbital is expressed by Formulas (5) and (6), where the number of holes of the reference sample (using a Pt metal foil) is h_{Tr}.

h_{TS}=(1+fd)h_{Tr} (5)

fd=({(A′₃ₛ−A′₃ᵣ)+1.11(A′₂ₛ−A′₂ᵣ)}/(A₃ᵣ+1.11A₂ᵣ) (6)

In Formula (6), A′₃ₛ and A′₂ₛ are respectively an integrated absorption intensity of the PtLIII edge and an integrated absorption intensity of the PtLII edge of the normalized absorption spectrums of the sample. A′₃ᵣ and A′₂ᵣ are respectively an integrated absorption intensity of the PtLIII edge and an integrated absorption intensity of the PtLII edge of the normalized absorption spectrums of the reference sample. Further, A₃ᵣ and A₂ᵣ are respectively integrated absorption intensities originated from the platinum 5d vacant orbital of the PtLIII edge and the PtLII edge of the reference sample, and are expressed by Formulas (7) and (8) by using the number of holes h_{5/2} of platinum 5d_{5/2} vacant orbital and the number of holes h_{3/2} of platinum 5d_{3/2} vacant orbital.

A₃ᵣ=(A′₃ᵣ−A′₂ᵣ)(h_{5/2}+h_{3/2})/h_{5/2} (7)

A₂ᵣ=(A′₃ᵣ−A′₂ᵣ)h_{3/2})/h_{5/2} (8)

In addition, as ratio of the number of holes (h_{5/2}/h_{3/2}), ratio of the number of holes (h_{5/2}/h_{3/2})=2.9 (Non-patent document 5) obtained by relativity tight-biding band calculation considering not only the 5d orbital but also mixture with 6s6p orbital for Pt simple substance metal is adopted. Further, as the number of holes of the Pt simple substance metal (h_{Tr}, Formula (5)), the number of holes of the 5d vacant orbital h_{Tr}=0.3 (pcs) (Non-patent documents 4 and 6) obtained by the first principle calculation by APW (augmented-plane-wave) method as a method for favorably connecting atomic intra-sphere with extra-sphere plane wave as atomic orbitalal function is adopted for the Pt simple substance.

Further, numerical integration is performed by using the normalized X-ray absorption spectrums illustrated in FIG. 2(C) in which the energy axes (horizontal axes) of the PtLIII edge absorption spectrum and the PtLII edge absorption spectrum are normalized and the integration range is normalized. Thereby, the integrated absorption intensities in the PtLIII edge and the PtLII edge, that is, N₃ₛ, A′₂ₛ, A′₃ᵣ, and A′₂ᵣ are obtained.

A′₃ᵣ and A′₂ᵣ are obtained by the normalized X-ray absorption spectrums illustrated in FIG. 2(C) of the reference sample, A₃ᵣ and A₂ᵣ are obtained by Formulas (7) and (8), fd is obtained by Formula (6), and the number of holes h_{TS} of the platinum 5d vacant orbital in the Pt-containing catalyst is able to be obtained by Formula (5).

Next, as the Pt-containing catalyst in the present invention, a description will be given of examples of the PtRu catalyst. It is to be noted that the description will be hereinafter given of the following catalyst composition, since such a composition demonstrates the best effect for a catalyst that contains Ru in addition to Pt and is supported carbon. However, the applicable catalyst composition is not limited thereto.

### EXAMPLES

### Preparation of the PtRu Catalyst

The PtRu catalyst supported by carbon was prepared as follows. 1.09 mL of 0.98 M ruthenium chloride (RuCl₃) aqueous solution and 18 mL of 7.35 M sodium acetate (CH₃COONa)) were sufficiently mixed to obtain uniform solution. After that, the solution was added with 200 mg of carbon black (Ketjen black), was vigorously stirred to obtain uniform dispersed state. Further, while stirring was continued, 10.7 mL of 1.0 M boron sodium hydroxide (NaBH₄) aqueous solution was dropped to the solution, and thereby carbon-supported Ru nanoparticle dispersion liquid was obtained.

While the dispersion liquid was stirred, 3.4M chloroplatinic (H₂PtCl₆) aqueous solution (Vₐ mL) and 1.0 M boron sodium hydroxide aqueous solution (34 Vₐ mL) were concurrently dropped and added to the dispersion liquid (however, Va was determined so that molar ratio of Ru to Pt became a given value). Thereby carbon-supported PtRu nanoparticle dispersion liquid was obtained. The PtRu nanoparticles supported by carbon were collected by a centrifugal machine, and were purified with the use of a large quantity of water. Accordingly, the PtRu catalyst was obtained.

The composition of the PtRu catalyst formed as described above will be shown below.

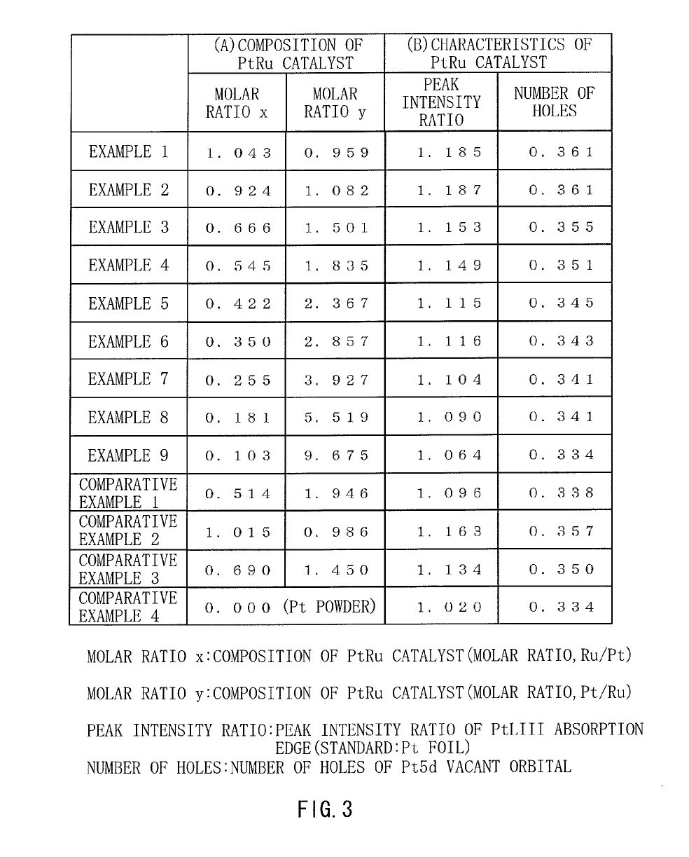

FIG. 3 is a diagram for explaining the compositions of the PtRu catalysts (A) and the characteristics thereof (B) in the examples of the present invention.

As illustrated in FIG. 3(B), molar ratios x (Ru/Pt) in the PtRu catalysts of Example 1 to Example 9 are in the range about from 0.1 to 1.0 both inclusive (in the range about from 1 to 10 both inclusive if expressed by molar ratio y (Pt/Ru)).

In addition, PtRu catalysts of Comparative example 1 to Comparative example 3 are commercially available, and are not supported by carbon. The PtRu catalyst of Comparative example 1 is made by BASF (Unsupported Pt2Ru black), the PtRu catalysts of Comparative example 2 and Comparative example 3 are made by Tanaka Holdings Co., Ltd., and molar ratios x (Ru/Pt) (molar ratio y (Pt/Ru)) calculated from analytical values are illustrated in FIG. 3(B). Further, Comparative example 4 is a Pt metal simple substance powder sample (Nilaco make, PT-354011 (300 mesh, 99.98)).

<Measurement of Absorption Spectrums>

In examples, catalyst particles supported by carbon were used as a sample, and X-ray absorption spectrums thereof were measured as follows.

A tape was uniformly coated with the catalyst particles, and the number of tapes coated with the catalyst particles was adjusted so that appropriate absorption intensity was obtained to obtain measurement samples. The X-ray absorption spectrums were measured respectively for the Pt LIII absorption edge and the Pt LII absorption edge by using a synchrotron orbital radiation experiment facility (SPring-8). Though the X-ray absorption spectrums were tried to be measured by both transmission method and fluorescence method, measurement results of the X-ray absorption spectrums by fluorescence method are herein shown. However, for a Pt foil (thickness: 10 μm) as a reference sample, the X-ray absorption spectrum was measured by transmission method.

As described above for FIG. 2, the absorption spectrum of the PtLIII absorption edge was obtained as follows. While adjusting incident X-ray energy back and forth the PtLIII edge, a fluorescent X-ray intensity generated by exciting the PtLIII edge in each energy was divided by an incident X-ray intensity. The absorption spectrum of the Pt LII absorption edge was similarly obtained.

The spectrums were straight-line-approximated in the region with lower energy than that of the absorption edge (the pre-edge region), the spectrums were quadratic curve-approximated in the region with higher energy than that of the absorption edge (the post edge region), intensity difference between the quadratic curve and the straight line became 1, and thereby the entire spectrums were normalized.

It is important to appropriately set the energy range of the approximated spectrums. In particular, if the post edge region is set to the vicinity of the absorption edge, the absorption peak intensity is inappropriately changed, and the fixed quantity of the state density becomes an error. In this case, where the PtLIII absorption edge energy was E₃ and the PtLII absorption edge energy was E₂, the pre-edge region was set to from (E₃−270) eV to (E₃−110) eV both inclusive, and the post-edge region was set to from (E₃+150) eV to (E₃+765) eV both inclusive in the LIII edge. Meanwhile, the pre-edge region was set to from (E₂−270) eV to (E₂−110) eV both inclusive, and the post-edge region was set to from (E₂+150) eV to (E₂+550) eV both inclusive in the LII edge.

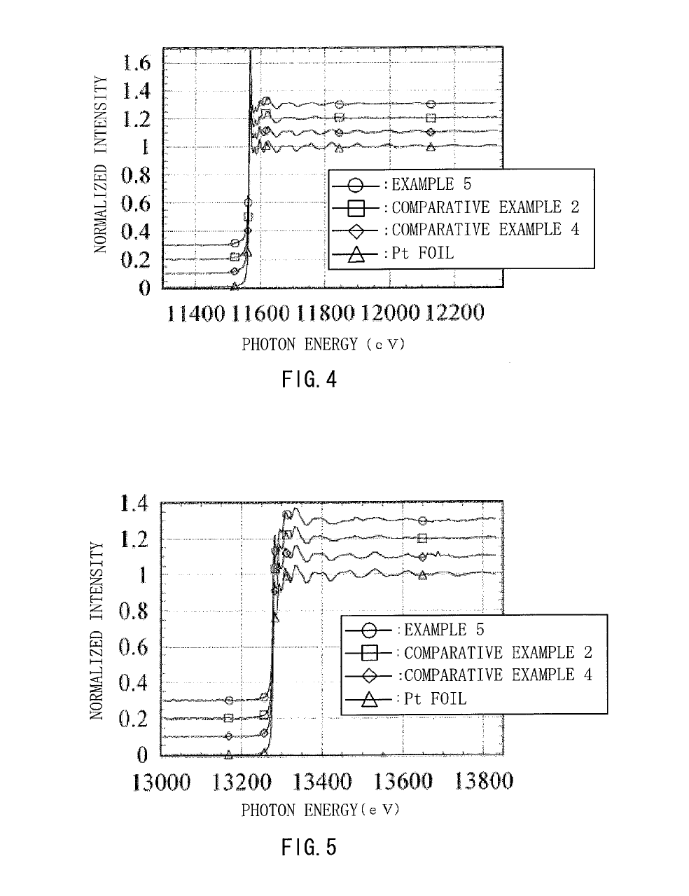

FIG. 4 to FIG. 7 illustrate examples of normalized X-ray absorption spectrums of the PtLIII edge and the PtLII edge measured respectively for Example 5 (x=0.422, where the molar ratio of Ru to Pt is x), Comparative example 2 (x=0.015), Comparative example 4 (x=0.000), and the Pt foil (x=0.000) obtained as described above.

FIG. 4 is a diagram for explaining an example of the normalized X-ray absorption spectrum of the PtLIII absorption edge in the example of the present invention. In FIG. 4, the horizontal axis indicates photon energy, and the vertical axis indicates an intensity of the normalized X-ray absorption spectrum (X-ray absorption intensity).

FIG. 5 is a diagram for explaining the example of the normalized X-ray absorption spectrum of the PtLII absorption edge in the example of the present invention. In FIG. 5, the horizontal axis indicates photon energy, and the vertical axis indicates an intensity of the normalized X-ray absorption spectrum (X-ray absorption intensity).

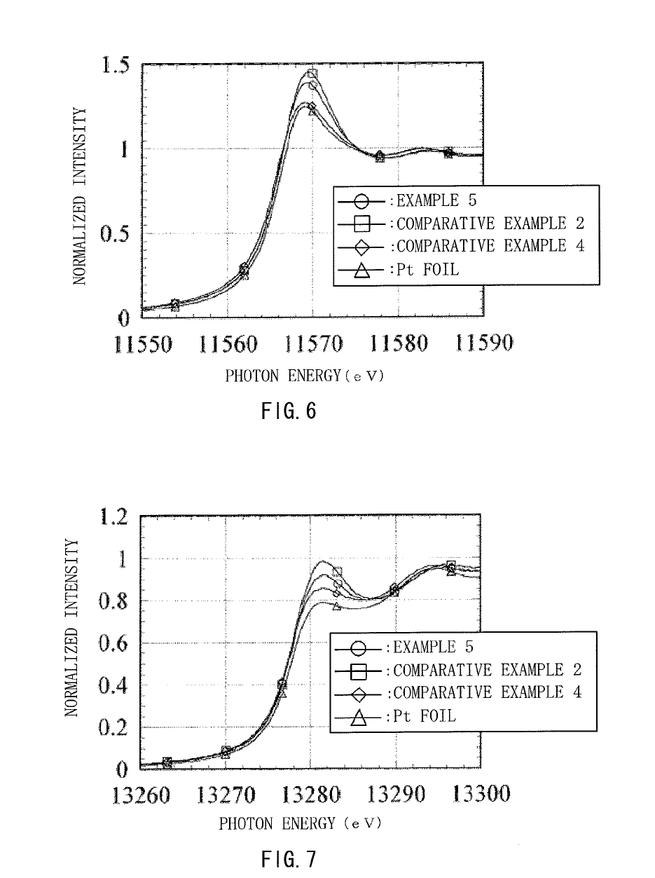

FIG. 6 is an enlarged diagram for explaining the example of the normalized X-ray absorption spectrum of the PtLIII absorption edge in the example of the present invention. In FIG. 6, the horizontal axis indicates photon energy, and the vertical axis indicates an intensity of the normalized X-ray absorption spectrum (X-ray absorption intensity).

FIG. 7 is an enlarged diagram for explaining the example of the normalized X-ray absorption spectrum of the PtLII absorption edge in the example of the present invention. In FIG. 7, the horizontal axis indicates photon energy, and the vertical axis indicates an intensity of the normalized X-ray absorption spectrum (X-ray absorption intensity).

It is to be noted that in FIG. 4 and FIG. 5, the normalized X-ray absorption spectrums at the PtLIII absorption edge are illustrated by being shifted in the vertical axis direction for facilitating visualization. Further, as illustrated in FIG. 4 and FIG. 5, it is found that respectively in the pre-edge region and the post-edge region, overall trend of the absorption spectrum shape is flat, and the height of the absorption intensity is normalized as 1.

The PtLIII absorption edge is generated by electric dipole transition of an electron from Pt2P_{3/2} inner shell orbital to platinum 5d_{5/2} vacant orbital and platinum 5d_{3/2} vacant orbital. The absorption edge peak (see FIG. 4 and FIG. 6) in the vicinity of incident X-ray energy 11570 eV reflects state density of the platinum 5d_{5/2} vacant orbital and the platinum 5d_{3/2} vacant orbital.

Meanwhile, the PtLII absorption edge is generated by electric dipole transition of an electron from Pt2p_{1/2} inner shell orbital to the platinum 5d_{3/2} vacant orbital. The absorption edge peak (see FIG. 5 and FIG. 7) in the vicinity of incident X-ray energy 13280 eV reflects state density of the platinum 5d_{3/2} vacant orbital. It is to be noted that in both the LIII absorption edge and the LII absorption edge, transition component to nonlocalized 6s vacant orbital is slightly mixed.

FIG. 3(B) illustrates ratios of the absorption edge peak intensity of the LIII absorption edge in the examples and the comparative examples with respect to the absorption edge peak intensity of the PtLIII absorption edge of the Pt foil obtained by the normalized X-ray absorption spectrums as illustrated in FIG. 4 to FIG. 7. The intensity ratio of the LIII absorption edge has a strong correlation with composition of the PtRu catalyst. Next, a description will be given of relation between the composition of the PtRu catalyst and the peak intensity (normalized intensity) of the PtLIII absorption edge.

<Relation Between the Composition of the PtRu Catalyst and the Peak Intensity of the PtLIII Absorption Edge>

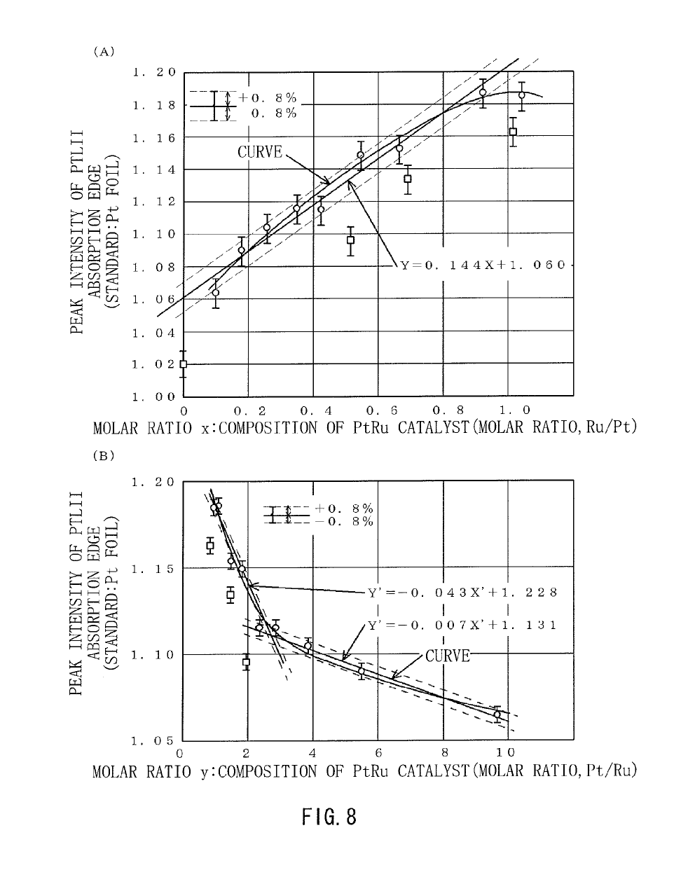

FIG. 8 is a diagram illustrating a relation between the composition of the PtRu catalyst and the peak intensity (relative intensity based on the Pt foil) of the PtLIII absorption edge in the examples of the present invention.

FIG. 8(A) is a diagram illustrating a plot of the composition x of the PtRu catalyst illustrated in FIG. 3(A) and the peak intensity ratio of the PtLIII absorption edge illustrated in FIG. 3(B). The horizontal axis indicates the molar ratio x of Ru to Pt (Ru/Pt) in the PtRu catalyst. The vertical axis indicates the relative intensity ratio.

When the peak intensity ratio of the PtLIII absorption edge is Y and the molar ratio is X (=x), the intensity ratio Y of the examples indicated by white circle is expressed by straight line Y=0.144X+1.060 that approximates the examples in the range of 0.1≦X≦1. The dashed lines indicate the range of (0.992xY) or more and (1.008xY) or less as the range of measurement error ±0.8%. In addition, for reference, the figure illustrates the curve obtained by smoothly connecting the dots, white circle.

Measurement error of the intensity ratio Y is about ±0.8%. FIG. 8(A) illustrates the error width as well. The straight line approximating the examples and white square indicating the comparative examples are not overlapped with each other even if the measurement error is counted in the range of 0.1≦X≦1, which shows that the Pt electron state of the catalyst of the examples is evidently different from that of the catalyst of the comparative examples.

FIG. 8(B) is a diagram illustrating a plot of the composition y of the PtRu catalyst illustrated in FIG. 3(A) and the peak intensity ratio of the PtLIII absorption edge illustrated in FIG. 3(B). The horizontal axis indicates the molar ratio y of Pt to Ru (Pt/Ru) in the PtRu catalyst. The vertical axis indicates the relative intensity ratio.

When the peak intensity ratio of the PtLIII absorption edge is Y′ and the molar ratio is X′ (=y), the intensity ratio Y′ of the examples indicated by white circle is expressed by Y′=−0.043X′+1.228 in the range of 1≦X′≦2.5 and Y′=−0.007X′+1.131 in the range of 2.5≦X′≦10, respectively. The dashed lines indicate the range of (0.992xY′) or more and (1.008xY′) or less as the range of measurement error ±0.8%. In addition, for reference, the figure illustrates the curve obtained by smoothly connecting the dots, white circle.

Measurement error of the intensity ratio Y is about ±0.8%. FIG. 8(B) illustrates the error width as well. The straight line approximating the examples and white square indicating the comparative examples are not overlapped with each other even if the measurement error is counted in the range of 1≦X′≦2, which shows that the Pt electron state of the catalyst of the examples is evidently different from that of the catalyst of the comparative examples as the result of FIG. 8(A).

Next, the number of holes of the platinum 5d vacant orbital is obtained. A description will be given of relation between the composition of the PtRu catalyst and the number of holes of the platinum 5d vacant orbital.

<The Number of Holes of the Platinum 5d Vacant Orbital>

The number of holes of the platinum 5d vacant orbital of the PtRu catalyst is able to be obtained by Formula (5) to Formula (8) by the foregoing method.

Numerical integration was performed by using the normalized X-ray absorption spectrums as illustrated in FIG. 2(C) in which the energy axes of the PtLIII edge absorption spectrum and the PtLII edge absorption spectrum were commonalized and the integration ranges were commonalized. Thereby, the integrated absorption intensities at the PtLIII edge and the PtLII edge, that is, A′₃ₛ, A′₂ₛ, A′₃ᵣ, and A′₂ᵣ were obtained. Further, A′₃ᵣ and A′₂ᵣ were obtained from the normalized X-ray absorption spectrums as illustrated in FIG. 2(C) of the reference sample. A₃ᵣ and A₂ᵣ were obtained by Formulas (7) and (8). Further, fd was obtained by Formula (6). The number of holes h_{TS} of the platinum 5d vacant orbital in the Pt-containing catalyst was obtained by Formulas (5) by respectively adopting h_{5/2}/h_{3/2}=2.9 as ratio of the number of holes and h_{Tr}=0.3 as the number of holes of the 5d vacant orbital of the Pt simple metal as described above.

First, it is necessary to obtain an integrated absorption intensity of the Pt LIII edge and an integrated absorption intensity of the Pt LII edge. It is necessary to commonalize photon energy axes of the Pt LIII edge absorption spectrum and the Pt LII edge absorption spectrum and commonalize the integration ranges. As illustrated in FIG. 4 to FIG. 7, in the LIII edge absorption spectrum and the LII edge absorption spectrum, oscillation structure as extended X-ray absorption fine structure (EXAFS) is generated in the high energy region of several tens of eV or more from the absorption edge.

The foregoing fact reflects each local structure around each Pt atom (structure composed of atoms in the range of about several Å from each Pt atom such as the first proximity atom and the second proximity atom), and such structure of the LIII edge is inherently identical with that of the LII edge. Thus, the energy axis was adjusted so that the EXAFS oscillation of the LIII edge corresponds with that of the LII edge. A description will be given of spectrums in the vicinity of the absorption edges in which the LIII edge and the LII edge are conformable by taking the Pt foil as an example.

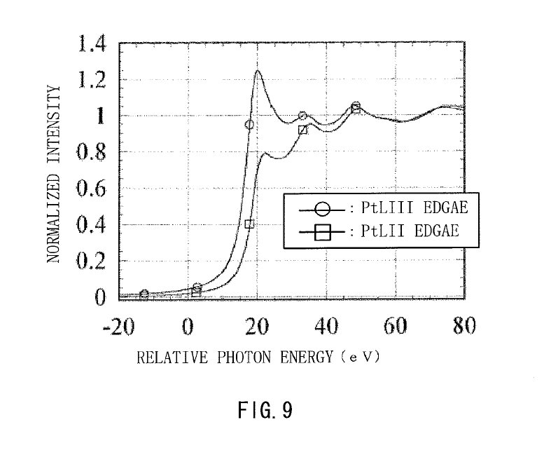

FIG. 9 is a diagram for explaining the Pt LIII absorption edge X-ray absorption spectrum and the Pt LII absorption edge X-ray absorption spectrum of the Pt foil with its energy axis adjusted in the example of the present invention. The horizontal axis indicates relative photon energy (E), and the vertical axis indicates intensity of the normalized X-ray absorption spectrums (X-ray absorption intensity) of the PtLIII absorption edge and the PtLII absorption edge.

Specifically, 11549 eV (document value) of absorption edge energy was subtracted from horizontal axis energy of the Pt LIII edge absorption spectrum. With respect to such resultant, the Pt LII edge absorption spectrum was shifted so that the EXAFS becomes conformable. For spectrums of the samples of the examples and the comparative examples, similar process was made. In the range from 0 to 50 eV both inclusive, there was a spectrum intensity difference between the LIII edge and the LII edge. In such a range, each spectrum intensity was integrated, and thereby integrated absorption intensities A′₃ᵣ and A′₂ᵣ in Formulas (7) and (8) of the Pt foil as a reference sample were obtained. Formulas (7) and (8) use a fact that the integrated intensity difference is proportional to h_{5/2}.

FIG. 3(B) illustrates the number of holes h_{TS} of the platinum 5d vacant orbital obtained as above for the examples and the comparative examples. The number of holes h_{TS} of the platinum 5d vacant orbital has a strong corelation to the composition of the PtRu catalyst. Next, a description will be given of the relation between the composition of the PtRu catalyst and the number of holes h_{TS} of the platinum 5d vacant orbital.

<Relation Between the PtRu Catalyst Composition and the Number of Holes of the Platinum 5d Vacant Orbital>

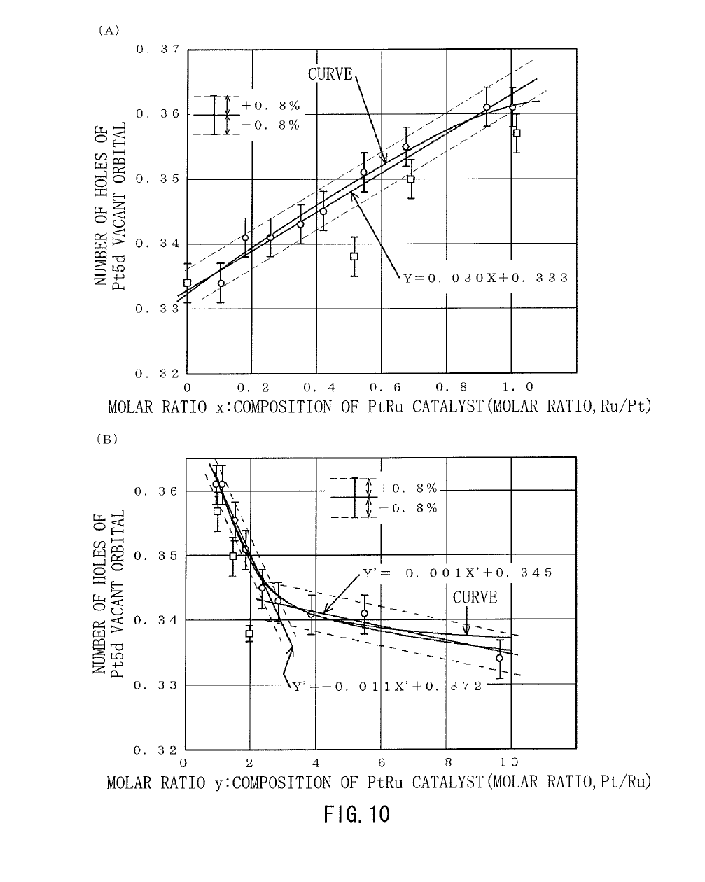

FIG. 10 is a diagram for explaining the relation between the composition of the PtRu catalyst and the number of holes of the platinum 5d vacant orbital in the examples of the present invention. In FIG. 10, the horizontal axis indicates the molar ratio x of Ru to Pt (Ru/Pt) in the PtRu catalyst. The vertical axis indicates the number of holes of the platinum 5d vacant orbital.

FIG. 10(A) is a diagram illustrating a plot of the composition x of the PtRu catalyst illustrated in FIG. 3(A) and the number of holes of the platinum 5d vacant orbital illustrated in FIG. 3(B). The horizontal axis indicates the molar ratio x of Ru to Pt (Ru/Pt) in the PtRu catalyst. The vertical axis indicates the number of holes of the platinum 5d vacant orbital.

As illustrated in FIG. 10(A), when the number of holes of the platinum 5d vacant orbital is Y and the molar ratio is X (=x), the number of holes Y of the platinum 5d vacant orbital of the examples indicated by white circle is expressed by straight line Y=0.030X+0.333 that approximates the examples in the range of 0.1≦X≦1. The dashed lines indicate the range of (0.992xY) or more and (1.008xY) or less as the range of measurement error ±0.8%. For reference, the figure illustrates the curve obtained by smoothly connecting the dots “∘.”

Measurement error of the number of holes Y of the platinum 5d vacant orbital is about ±0.8%. FIG. 10(A) illustrates the error width as well. The straight line approximating the examples and white square indicating the comparative examples are not overlapped with each other even if the measurement error is counted in the range of 0.1≦X≦1, which shows that the Pt electron state of the catalyst of the examples is evidently different from that of the catalyst of the comparative examples.

FIG. 10(B) is a diagram illustrating a plot of the composition y of the PtRu catalyst illustrated in FIG. 3(A) and the number of holes of the platinum 5d vacant orbital illustrated in FIG. 3(B). The horizontal axis indicates the molar ratio y of Pt to Ru (Pt/Ru) in the PtRu catalyst. The vertical axis indicates the number of holes of the platinum 5d vacant orbital.

As illustrated in FIG. 10(B), when the number of holes of the platinum 5d vacant orbital is Y′ and the molar ratio is X′ (=y), the number of holes Y′ of the platinum 5d vacant orbital of the examples indicated by white circle is expressed by Y′=−0.001X′+0.345 in the range of 1≦X′≦2.5 and Y′=−0.001X′+0.372 in the range of 2.5≦X′≦10, respectively. The dashed lines indicate the range of (0.992xY′) or more and (1.008xY′) or less as the range of measurement error ±0.8%. In addition, for reference, the figure illustrates the curve obtained by smoothly connecting the dots, white circle.

Measurement error of the number of holes of the platinum 5d vacant orbital Y is about ±0.8%. FIG. 10(B) illustrates the error width as well. The straight line approximating the examples and white square indicating the comparative examples are not overlapped with each other even if the measurement error is counted in the range of 1≦X′≦2, which shows that the Pt electron state of the catalyst of the examples is evidently different from that of the catalyst of the comparative examples as the result of FIG. 10(A).

Next, a description will be given of characteristics of a fuel cell using the PtRu catalyst according to the present invention.

<Structure of the Fuel Cell>

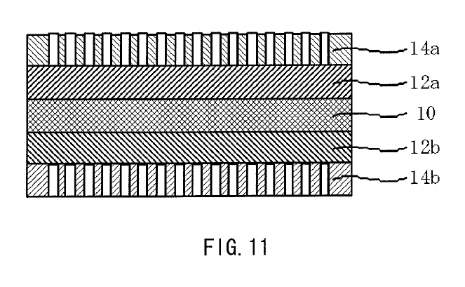

FIG. 11 is a cross sectional view for explaining a structure of a fuel cell in the examples of the present invention. The basic structure thereof is the same as that illustrated in FIG. 1.

The PtRu catalysts of the examples and the comparative examples were used as a fuel electrode 12a of a single cell of direct methanol fuel cells, and the fuel cells were evaluated. As an air electrode 12b, Pt-supporting carbon (manufactured by Tanaka Holdings Co., Ltd. and 67 wt % of platinum supported) was commonly used for all single cells.

First, catalyst powder was mixed with 10 wt % Nafion (registered trademark) aqueous solution (DE1021CS10afion (registered trademark) dispersed solution) to obtain slurry. At this time, the ratio between the catalyst powder and Nafion (registered trademark) ionomer was 2:1 for both the air electrode 12b and the fuel electrode 12a. A teflon (registered trademark) sheet was coated with the slurry, which was dried. After that, the sheet was cut out into a circular electrode being 10 mm in diameter. The platinum content in the circular electrode was 8 mg in the fuel electrode 12a and 5 mg in the air electrode 12b.

A membrane electrode assembly (MEA) was obtained by sandwiching a Nafion (registered trademark) film (15 mm×15 mm) being 50 μm thick as an electrolyte film 10 between the fuel electrode 12a and the air electrode 12b, and the resultant was hot-pressed for 10 minutes at 150 deg C. Both electrode sections of the MEA was covered with carbon paper (manufactured by Toray Industries, INC.) being 12 mm in diameter. Finally, the resultant was sandwiched between two PEEK plates as gas diffusion layers 14a and 14b, the MEA was screwed to obtain the single cell.

The PEEK plates have countless holes being 1 mm in diameter. Air supply from atmosphere of the air electrode 12b and methanol aqueous solution (80 wt %) supply to the fuel electrode 12a were made through the holes of the gas diffusion layers 14a and 14b without using a fan, a pump or the like under the passive conditions. Power generation evaluation was made by changing the current density to the electrode area, recording the voltage value at that time, and obtaining a current density-output density curve. Next, a description will be given of characteristics of the fuel cell using the PtRu catalyst.

<Characteristics of the Fuel Cell Using the PtRu Catalyst>

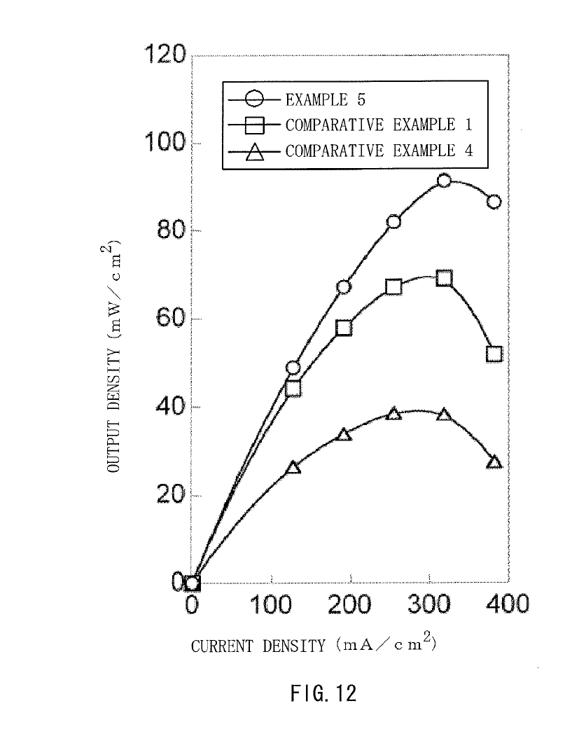

FIG. 12 is a diagram for explaining power generation characteristics of the fuel cells in the example of the present invention. In FIG. 12, the horizontal axis indicates a current density (mA/cm²), and the vertical axis indicates an output density (mW/cm²).

FIG. 12 illustrates power generation characteristics of the fuel cells using the catalysts according to Example 5, Comparative example 1, and Comparative example 4 as a representative example. Output densities at the current density of 300 mA/cm² are respectively 91 mW/cm², 70 mW/cm², and 39 mW/cm². Comparing Example 5 with Comparative example 1 having almost the same molar ratio x of Ru to Pt (Ru/Pt), output of the fuel cell using Example 5 is extremely larger, that is, about 1.3 times as much as that of Comparative example 1.

As described above, for improving catalyst activity, the number of holes of the platinum 5d vacant orbital is increased. Thereby, Pt—Co bond is weakened and oxidation by H₂O is promoted. Such action is regarded as an important factor, which may contribute to achieve high performance of the direct methanol fuel cell.

Further, in the foregoing explanation, the description has been given by taking the case using the catalyst of the present invention as a fuel electrode as an example. However, according to Non-patent document 7, in redox reaction in the oxygen electrode, as the platinum 5d vacant orbital is increased, chemical absorption of —OH from the electrolytic solution (Pt—OH) is increased, resulting in lowered catalyst activity. Thus, the catalyst of the present invention is able to be used for an oxygen electrode. In this case, again, a fuel cell with superior power generation characteristics is able to be possibly realized.

Further, in the foregoing explanation, the description has been given of the PtRu catalyst. However, in the case where a catalyst composed of a metal other than Ru, Pt, and a catalyst is used, high catalyst activity is also shown and effect similar to the foregoing effect is also able to be obtained. Further, even if the PtRu catalyst contains a metal other than Ru in addition to Ru, high catalyst activity is also shown and effect similar to the foregoing effect is also able to be obtained.

The present invention has been described with reference to the embodiment. However, the present invention is not limited to the foregoing embodiment, and various modifications may be made based on the technical idea of the present invention.

### INDUSTRIAL APPLICABILITY

According to the present invention, a catalyst having high catalyst activity is able to be provided, and a fuel cell having superior output characteristics is able to be realized.

1. A platinum-containing catalyst, wherein when ratio of a peak intensity of a PtLIII absorption edge of a normalized X-ray absorption spectrum of the platinum-containing catalyst with respect to a peak intensity of a PtLIII absorption edge of a normalized X-ray absorption spectrum of a platinum simple substance metal foil having a thickness of 10 μm is Y, and molar ratio of total of metal elements other than platinum to the platinum in the platinum-containing catalyst is X, Y=0.144X+1.060 is established in the range of 0.1≦X≦1.

2. The platinum-containing catalyst according to claim 1, wherein the molar ratio is 0.25≦X≦1.

3. The platinum-containing catalyst according to claim 1, wherein the molar ratio is 0.2≦X≦0.6.

4. The platinum-containing catalyst according to claim 1, wherein when molar ratio of the platinum to the total of the metal elements is X′, Y=−0.043X′+1.228 is established in the range of 1≦X′≦2.5 and Y=−0.007X′+1.131 is established in the range of 2.5≦X′≦10.

5. The platinum-containing catalyst according to claim 1, wherein the metal element is ruthenium.

6. A platinum-containing catalyst, wherein when the number of holes of a platinum 5d vacant orbital in a platinum simple substance metal foil is 0.3, molar ratio of total of metal elements other than platinum to the platinum in the platinum-containing catalyst is X, and the number of holes of a platinum 5d vacant orbital in the platinum-containing catalyst is N, N=0.030X+0.333 is established in the range of 0.1≦X≦1.

7. The platinum-containing catalyst according to claim 6, wherein the molar ratio is 0.25≦X≦1.

8. The platinum-containing catalyst according to claim 6, wherein the molar ratio is 0.2≦X≦0.6.

9. The platinum-containing catalyst according to claim 6, wherein when molar ratio of the platinum to the total of the metal elements is X′, N=−0.011X′+0.372 is established in the range of 1≦X′≦2.5 and N=−0.001X′+0.345 is established in the range of 2.5≦X′≦10.

10. The platinum-containing catalyst according to claim 6, wherein the metal element is ruthenium.

11. A platinum-containing catalyst,
wherein when ratio of a peak intensity of a PtLIII absorption edge of a normalized X-ray absorption spectrum of the platinum-containing catalyst with respect to a peak intensity of a PtLIII absorption edge of a normalized X-ray absorption spectrum of a platinum simple substance metal foil having a thickness of 10 μm is Y, and molar ratio of total of metal elements other than platinum to the platinum in the platinum-containing catalyst is X, Y=0.144X+1.060 is established in the range of 0.1≦X≦1, and
when the number of holes of a platinum 5d vacant orbital in the platinum simple substance metal foil is 0.3 and the number of holes of a platinum 5d vacant orbital in the platinum-containing catalyst is N, N=0.030X+0.333 is established in the range of 0.1≦X≦1.

12. The platinum-containing catalyst according to claim 11, wherein the molar ratio is 0.25≦X≦1.

13. The platinum-containing catalyst according to claim 11, wherein the molar ratio is 0.2≦X≦0.6.

14. The platinum-containing catalyst according to claim 11, wherein when molar ratio of the platinum to the total of the metal elements is X′, Y=−0.043X′+1.228 is established in the range of 1≦X′≦2.5 and Y=−0.007X′+1.131 is established in the range of 2.5≦X′≦10, N=−0.011X′+0.372 is established in the range of 1≦X′≦2.5, and N=−0.001X′+0.345 is established in the range of 2.5≦X′≦10.

15. The platinum-containing catalyst according to claim 11, wherein the metal element is ruthenium.

16. A fuel cell comprising a catalyst electrode using a platinum-containing catalyst,
wherein in the platinum-containing catalyst, when ratio of a peak intensity of a PtLIII absorption edge of a normalized X-ray absorption spectrum of the platinum-containing catalyst with respect to a peak intensity of a PtLIII absorption edge of a normalized X-ray absorption spectrum of a platinum simple substance metal foil having a thickness of 10 μm is Y, and molar ratio of total of metal elements other than platinum to the platinum in the platinum-containing catalyst is X, Y=0.144X+1.060 is established in the range of 0.1≦X≦1.

17. A fuel cell comprising a catalyst electrode using a platinum-containing catalyst,
wherein in the platinum-containing catalyst, when the number of holes of a platinum platinum 5d vacant orbital in a platinum simple substance metal foil is 0.3, molar ratio of total of metal elements other than platinum to the platinum in the platinum-containing catalyst is X, and the number of holes of a platinum 5d vacant orbital in the platinum-containing catalyst is N, N=0.030X+0.333 is established in the range of 0.1≦X≦1.

18. A fuel cell comprising a catalyst electrode using a platinum-containing catalyst,
wherein in the platinum-containing catalyst, where ratio of a peak intensity of a PtLIII absorption edge of a normalized X-ray absorption spectrum of the platinum-containing catalyst with respect to a peak intensity of a PtLIII absorption edge of a normalized X-ray absorption spectrum of a platinum simple substance metal foil having a thickness of 10 μm is Y, and molar ratio of total of metal elements other than platinum to the platinum in the platinum-containing catalyst is X, Y=0.144X+1.060 is established in the range of 0.1≦X≦1, and
when the number of holes of a platinum 5d vacant orbital in the platinum simple substance metal foil is 0.3 and the number of holes of a platinum 5d vacant orbital in the platinum-containing catalyst is N, N=0.030X+0.333 is established in the range of 0.1≦X≦1.

19. The fuel cell according to any of claim 16 to claim 18, wherein the catalyst electrode is used for a fuel electrode side.
